(19) United States
(12) Patent Application Publication
(10) Pub. No.: US 2013/0129455 A1
(43) Pub. Date: May 23, 2013

(54) STORAGE AND ORDER COLLECTION SYSTEM

(71) Applicant: Hugo Victor De Vries, Ch Almere (NL)

(72) Inventor: Hugo Victor De Vries, Ch Almere (NL)

(73) Assignee: I-COLLECTOR HOLDING B.V., CH Almere (NL)

(21) Appl. No.: 13/813,480

(22) PCT Filed: Aug. 2, 2011
(86) PCT No.: PCT/NL11/00057

§ 371 Date: Jan. 31, 2013

(30) Foreign Application Priority Data
Aug. 3, 2010 (NL) 1038148

(51) Int. Cl. B65G 1/04

(52) U.S. Cl. CPC B65G 1/04
USPC 414/277; 414/807

(57) ABSTRACT

Device for storing articles and forming groups thereof, includes a frame having a first series of mutually parallel elongated storage sections, that extend between a first end and a second end of the frame, a number of holders for the articles, the storage sections having holder supports, first and second platforms arranged at the first and the second end of the frame, respectively, for accommodating at least one holder, first movement elements for moving the platforms, from one storage section to another storage section, second movement elements for horizontally moving at least one holder from the platform at the first end of the frame to the holder supports of a selected storage section while moving one or more holders, from the selected storage section to the platform at the second end of the frame. At least at one longitudinal side of the device having one or more feeder devices.

### BACKGROUND OF THE INVENTION

The invention relates to a storage and order collection- or order picking system. The invention furthermore relates to a method for storing articles, particularly including order picking.

Storage and order picking systems are among others used in wholesale businesses, such as the trade in (spare) parts, and in retail businesses, such as apothecaries and supermarket delivery services.

In a first known system use is made of a frame in which a number of rows and columns of elongated storage sections are accommodated, which are oriented perpendicular to the supply side and which each are provided with a belt conveyor on which articles can be placed by a carrier that can be moved up and down and along the supply side. When an article has to be added to a selected storage section the belt conveyor is shifted up one place and the article is placed on the vacated spot on the belt conveyor. The articles placed previously then are shifted up one step. When receiving more than one article the belt conveyor is moved back in steps and the carrier picks up said articles. They are then taken to a collection location by the carrier, for putting the desired order together. A shortcoming of this system is the low speed. Furthermore the known system with drives for all belt conveyors of storage sections is complex and failure prone. When the depth of the system should be kept limited, more storage sections are required and the distances of movement for the carrier become longer.

In another known system, racks are positioned transverse to the main path, separated from one another by a transverse path, in which a carrier can be moved up and down and reciprocally. The racks form elongated storage sections, extending parallel to the transverse path, and from there, that means transverse to the storage sections, they are accessible by the carrier. This system has large dimensions in transverse direction.

### SUMMARY OF THE INVENTION

It is an object of the invention to provide a storage- and order picking system and -method that is able to function at high speed.

It is an object of the invention to provide a storage- and order picking system and -method that is able to function advantageously.

It is an object of the invention to provide a storage- and order picking system and -method that is able to function with a low risk of failure.

For achieving at least one of those objects, from one aspect, the invention provides a device for the storage of articles and the formation of groups of articles therefrom, comprising a frame having a first series of mutually parallel elongated storage sections, preferably positioned in a column set-up, that extend between a first end and a second end of the frame, furthermore comprising a number of holders, such as carriers, for the articles, wherein the storage sections are provided with holder supports on which a number of the holders can be supported for storage of the articles, wherein at the first end and the second end of the frame first and second platforms, respectively, have been arranged which each are adapted for accommodating at least one holder, and first movement means for moving said platforms, preferably simultaneously, from the one storage section to another storage section, wherein the device is provided with second movement means for horizontally moving at least one holder from the platform at the first end of the frame to the holder supports of a selected storage section while moving one or more holders, preferably representing a same holder length, from the selected storage section to the platform at the second end of the frame, wherein the device has main or longitudinal sides extending between the frame ends and at least at one longitudinal side is provided with one or more feeder devices and with third movement means for discharging an article from the feeder device to a selected storage section, wherein the device is provided with fourth movement means for moving the feeder device to the selected storage section.

The storage sections can be adapted for allowing a movement of the articles held by the holders thereof in a direction transverse to the storage section in question for discharge and/or accommodation of articles to or from, respectively, the device. The entry can then take place at the other side of the device than the output/exit.

By means of the invention a (storage) section can be used for the entry as a result of which the compactness is increased. Said entry section may for instance be used for assembling groups of (different) articles, in a process of order picking.

Advantageous embodiments are described in the attached claims 2-22 the contents of which should be considered inserted herein.

The entry and/or discharge need not conflict with the movement of articles from the one section to the other section in the device. Here, the platforms only need to be moved either up and down or reciprocally along both ends, as a result of which the profile of movement can be kept limited. The said holder length is the length that one or more holders take up considered in direction of the storage section in question. The storage section can remain occupied with holders over the full length. When accommodating a holder in a storage section, a holder is also discharged at the other end.

The speed can be enhanced when both platforms are adapted for supporting more than one holder.

The device can be further simplified when the second movement means are provided on the first and/or the second platform. One or two such platforms can then suffice.

In one embodiment the second movement means directly engage onto a holder at the end of the row of holders that is situated on the storage level with both platforms. In a simple embodiment the second movement means engage onto a holder that is situated on a platform, particularly are designed as a pusher. By pushing the holder on the one platform onto the storage level, the holder at the other end is pushed onto the other platform.

According to a further aspect, the invention provides a method for keeping articles in store/discharging articles and/or order picking of articles, wherein the articles are stored in a device, which device comprises a frame having a first series of elongated storage sections placed parallel to each other, preferably in a column set-up, and extending between a first end and a second end of the frame, furthermore comprising a number of holders for the articles, wherein the storage sections are provided with holder supports on which a number of the holders can be supported for storage of the articles, wherein at a longitudinal side of the frame articles are taken to a selected storage section and supplied thereto, in a direction transverse to the longitudinal direction of the storage section, wherein for discharging selected stored articles from the device, the holders holding those articles are moved to a longitudinal end of the frame and at that location are taken by a platform to a storage section intended for discharge (discharge or exit section) and are transferred thereto, wherein the articles are transferred from the discharge section, particularly transverse to the longitudinal side, to an output device.

Preferably at the first end and the second longitudinal end of the frame, a first and a second, respectively, movable platform has been arranged, wherein for retrieving the articles from store, the first platform and the second platform are taken to a selected storage section and an empty holder is received from the second platform on the holder supports of said storage section while discharging a holder with article from said storage section to the first platform, after which the holder with article is taken by the first platform to the discharge section, where the holder in question is received from the first platform onto the holder supports of the discharge section while transferring an empty holder from the same section to the second platform.

These methods can be further developed with the measures described in claims 23-33, the contents of which should be considered inserted herein.

From a further aspect the invention provides a method for keeping articles in store, wherein the articles are stored in a device, which device comprises a frame having a first series of elongated storage sections placed parallel to each other, preferably in a column set-up, and extending between a first end and a second end of the frame, furthermore comprising a number of holders for the articles, wherein the storage sections are provided with holder supports on which a number of the holders can be supported for storage of the articles, wherein at a longitudinal side of the frame articles are taken to a storage section designed as entry section and are supplied thereto, in a direction transverse to the longitudinal direction of the entry section, wherein for storing entered articles in a selected storage section of the device, the holders holding those articles are moved to a longitudinal end of the frame and at that location are taken by a platform to the selected storage section and are transferred thereto, wherein the articles are transferred from the storage section to an output device, preferably in a direction transverse to the longitudinal direction of the storage section.

Preferably the articles from the storage section are received by an output device that is vertically and/or horizontally moved along the storage sections, between a selected position for reception of an article and a location of output.

These methods can be further developed with corresponding (reversed) application of the measures described in claims 23-33, the contents of which should be considered inserted herein.

In the storage device there are at least two storage sections that can be approached from the side, transverse to the longitudinal direction of the storage sections, as a result of which products can be entered and discharged. In order to easily be able to place and remove products in one embodiment the product carriers are only provided with a transversely oriented raised front and rear side.

According to a further aspect the invention provides a device for storing articles and the formation of groups of articles therefrom, comprising a frame having a series of mutually parallel elongated storage sections, positioned in a column set-up, that extend between a first end and a second end of the frame, further comprising a number of holders, such as carriers, for the articles, wherein the storage sections are provided with holder supports on which a number of the holders can be supported for storage of the articles, wherein the frame has longitudinal ends and longitudinal sides extending in between them, wherein the device at a longitudinal side is provided with a feeder device that is movable to a selected storage section and to a selected position, particularly holder, along it for transferring one or more of the articles placed on the feeder device to said selected position/holder and transferring it thereto, wherein at the longitudinal ends the device is furthermore provided with, one set of movable elevators or platforms, preferably situated in line, for moving the holders and/or articles from the one storage section to another storage section, including an exit/discharge section intended for exit/discharge of articles, wherein at a longitudinal side, preferably the longitudinal side opposing the feeder device longitudinal side, the device is provided discharge means for from the exit/discharge section discharging articles to an output device.

The invention furthermore provides a device provided with one or more of the characterising measures described in the attached description and/or shown in the attached drawings.

The invention furthermore provides a method provided with one or more of the characterising measures described in the attached description and/or shown in the attached drawings.

The aspects and measures described in this description and the claims of the application and/or shown in the drawings of this application may where possible also be used individually. Said individual aspects may be the subject of divisional patent applications relating thereto. This particularly applies to the measures and aspects that are described per se in the sub claims.

### BRIEF DESCRIPTION OF THE DRAWINGS

The invention will be elucidated on the basis of a number of exemplary embodiments shown in the attached drawings, in which:

FIGS. 1A-C schematically show a front view, top view and side view, respectively, of an exemplary embodiment of a device according to the invention;

FIGS. 2A and 2B show a side view of a process of storing articles in the device of FIGS. 1A-C and a process of order picking in the device of FIGS. 1A-C, respectively;

FIGS. 3A-C show some details of an example of a process of transferring articles within a device according to the invention;

FIGS. 4A-C show a number of examples of use of an alternative embodiment of holders for a device according to the invention;

FIG. 5 shows a schematic top view of a comparable exemplary embodiment of a device according to the invention; and

FIGS. 6A-C show another embodiment of a device according to the invention.

### DETAILED DESCRIPTION OF THE DRAWINGS

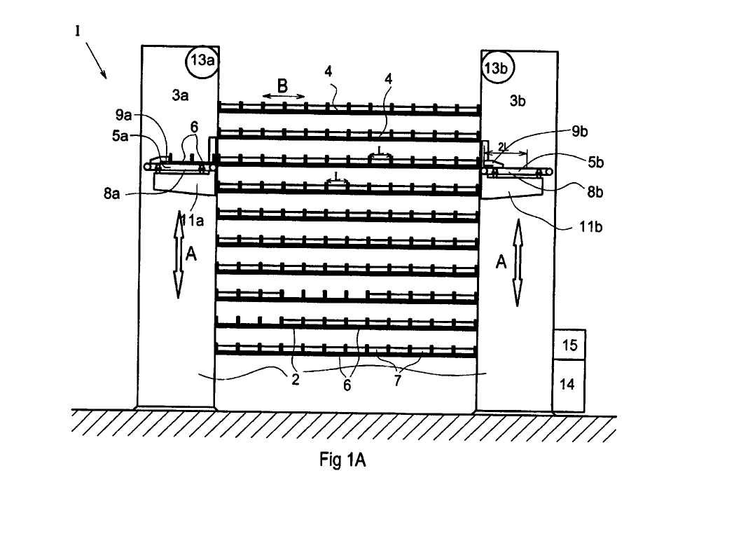

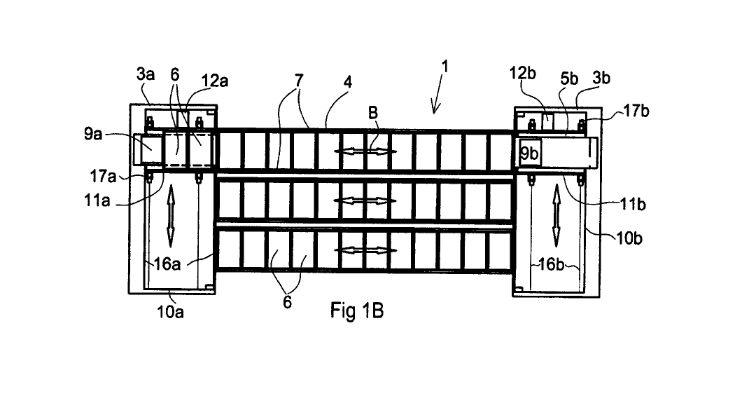

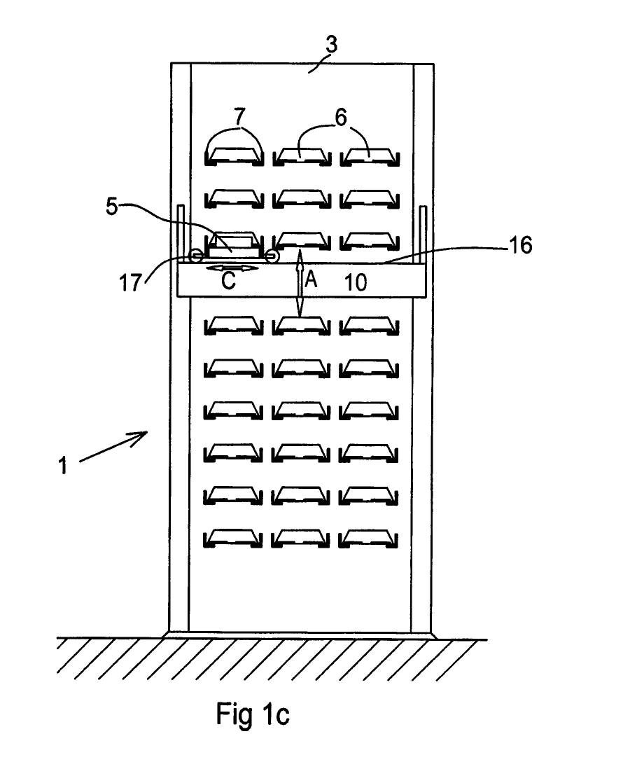

The exemplary embodiment 1 shown in FIGS. 1A-C is substantially column-shaped and comprises a frame 2 having two elevator shafts 3a,3b at two longitudinal ends and storage sections borne in between them, in this case storage levels 4, in this example nine, which in this example are positioned in three columns. In each elevator shaft 3a,b a platform 5a,b is accommodated, which can be moved up and down by electromotors 13a,b, direction A. In the device 1a number of carriers or holders for articles are housed.

Each platform 5a,b is supported on a frame 11 a,b and comprises a belt conveyor 8a,b that is drivable by means of electromotors 12a,b. On the belts 8a,b pushers 9a,b are attached for movement along with them. The belts 8a,b have a support surface of approximately 2 L, wherein L is the length of a holder 6, measured in main direction of a storage level 4, in this example corresponding with a module size.

The frames 11 a,b with platforms 5a,b are supported on a frame 10a,b by wheels 17a,b and can be moved in the direction C over rails 16a,b by means of electromotors, not shown, provided on the platforms.

Each storage level 4 comprises two support profiles 7, on which a series of holders 6 is supported, in a way so as to be easily shiftable in the direction B. The support profiles 7 have a support length of approximately a full number of lengths L of the holder 6, in this example 12 L.

For controlling the said electromotors a control unit 14 with programmable computer 15 is present.

The holders 6 are provided with unique identification marks, such as a barcode. For reading the barcodes sensors are present, that are functionally connected to the control unit 14/computer 15. In the control unit 14 a connection can be made between a holder and an article placed thereon, so that it is exactly known at what location in the device an article is situated and which article it is.

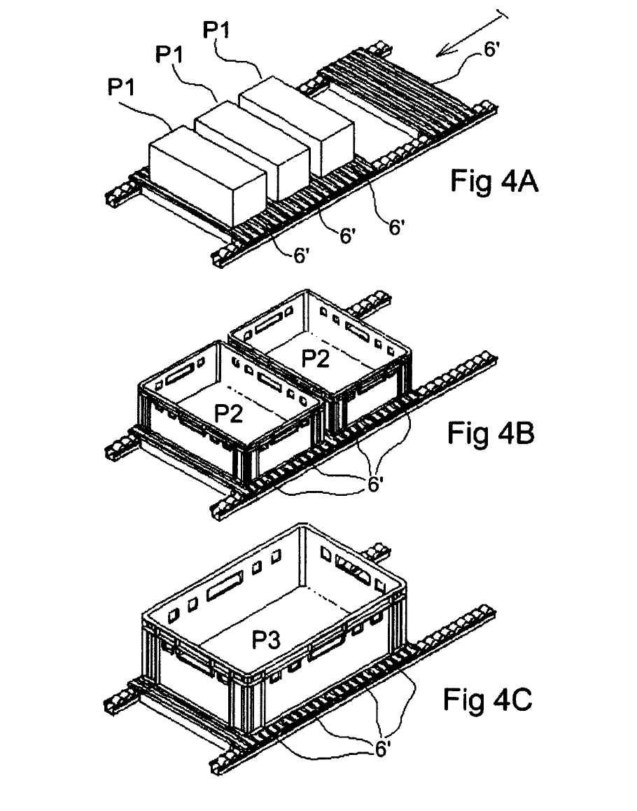

One of the storage sections 4 can be suitable for entry, for instance level 4a, and one for exit for instance level 4b. The entry level 4a and the exit level 4b can be situated at opposite main sides of the device 1, so that the direction of entry V can be the same as the direction of exit T, see FIG. 4. The entry and exit levels are situated at a level, which to a person involved in entering/outputting, is ergonomically advantageous.

When storing a group of identical articles Pi the articles are placed in the direction V on or in the holders 6 of entry level 4a. The platforms 5a,b have been taken to the same level and in line with the entry level 4a. After loading the belt 8b is activated. On the belt 8b there are two empty holders 6, on belt 8a none, so that the overall number of holders on platforms and storage levels is 3×9×12+2. The pusher 9b pushes said holders 6 at the right-hand side onto the support profiles 7 of the entry level. Said pushing force is transferred via the holders 6 of said level to the two leftmost holders 6 that are each carrying an article Pi. All holders 6 thus shift onwards to the left, while discharging the two loaded holders 6 to the belt 8a, direction D2. The belt 8a can then be idle or be driven synchronously.

After both holders 6 are positioned on the belt 8a, the platforms 5a,b are lifted, direction E, to the selected storage level 4. When the latter is situated in a different column movement will also take place in the direction C.

When the platforms 5a,b have come to be in line with the selected storage level 4, the belt 8a is activated in order to urge the loaded holders 6 by means of pusher 9a to the right, direction F1, onto the support profiles 7 of said level. As a result at the right-hand end two empty holders 6 are shifted onto the belt 8b, in a comparable manner as described above for the left-hand end. After the loaded holders have been discharged the platforms 5a,b can be moved downwards again, direction G, in order to be brought in line again with entry level 4a, after which the same process can start over again. This can be repeated as long as there are still empty holders at the selected storage level. After that another storage level can be used.

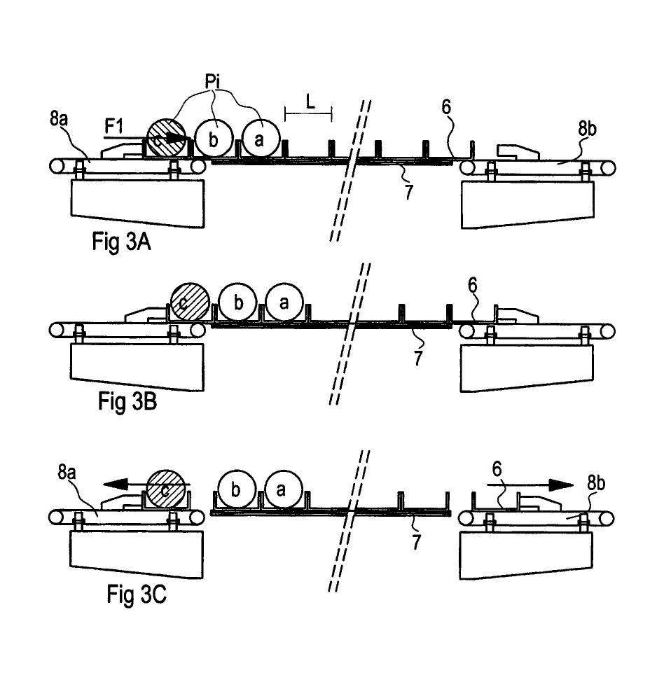

When the articles Pi are different and for that reason have to be stored at different storage levels, platform 5a will be used for first discharging one article Pi to the one selected storage level, and subsequently the next, different article on another selected storage level. This is for instance shown in FIGS. 3A-C, where the article b is discharged to a storage level, but a different article c is still kept on the belt 8a. As shown, at the end of discharging, the belts 8a,b can be driven in a slightly opposite manner, in order to make the holder 6 with article c and the empty holder on belt 8b entirely free from the storage level, before moving the platforms 5a,b.

It is also possible to assign storage levels to certain destinations. In that case for instance identical articles Pi can be distributed over different levels. Other, different articles Pi can then be distributed over the same levels, or over a part thereof. Thus on each assigned level an individual collection of articles is brought together, also grouped.

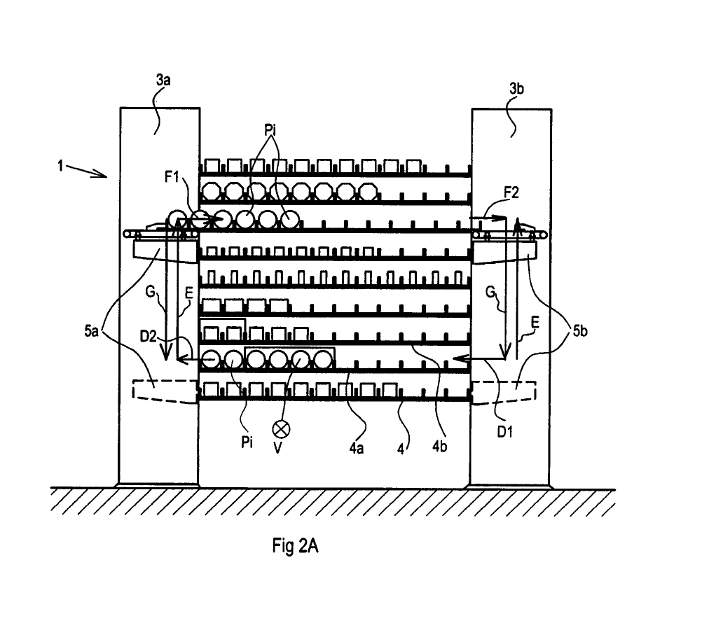

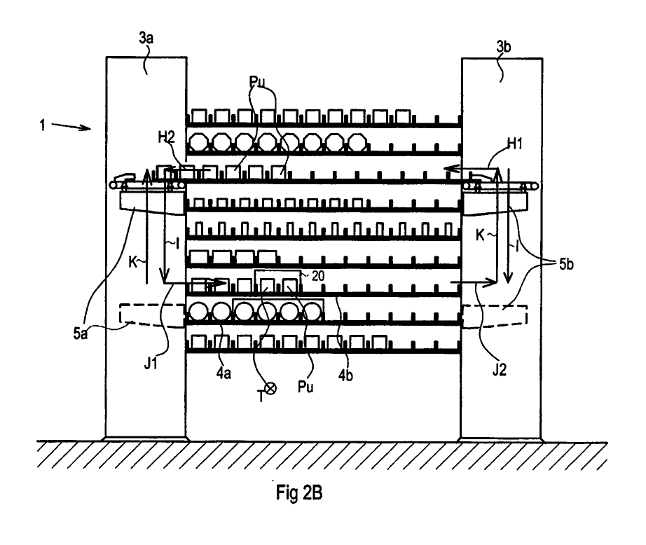

For picking an order of for instance articles Pu the platforms 5a,b are brought in line with the selected storage level 4 (FIG. 2B). Belt 8b is subsequently driven in order to push the empty holders 6 on it to the left, direction H1, by means of pusher 9b. As a result thereof at the left-hand end, two loaded holders 6 are urged onto the belt 8a, direction H2. Subsequently the platforms 5a,b are moved downwards, direction I, until they are in line, optionally after movement in direction C (FIG. 10), with exit level 4b. At that location the belt 8a is activated, so that by means of the pusher 9a two loaded holders 6 are urged in the direction J1 onto the support profiles 7 of the exit level 4b. As a result thereof at the right-hand end two empty holders 6 are pushed onto the belt 8b, direction J2. After the loaded holders have been transferred to the exit level 4b the platforms 5a,b can be moved upwards again, direction K, in order to be brought in line again with the level where the articles have to be removed, after which the same process can start over again.

When the order is ready, or room has to be made, the articles Pu can be removed in the direction T from the exit level 4b, via passage 20.

It is also possible to make an order of different articles, for which purpose articles are taken from different storage levels in the described manner and are placed on the exit level.

In the aforementioned case of grouping articles on assigned levels the collection has already taken place and for instance the entire group can be transferred in steps from one level to the exit level.

It is noted that instead of being loaded with singular articles, the holders can also be loaded with a multiple of articles, or a combination of articles, for instance a package of medicines customized to a patient.

It is furthermore noted that the holders 6 can also be designed so as to be multiple, having multiple compartments.

For facilitating in a direction transverse to the main direction of a storage section the holders can be substantially U-shaped, wherein the legs form upright edges or walls that are transverse to said main direction.

In an embodiment, see FIGS. 4A-C, it is also possible to use holders 6′ that do not have upright walls or edges that are transverse to the main direction, and as shown, merge into each other with their support surfaces. An advantage thereof is that adjacently situated holders are able to provide a large support surface, as a result of which articles that are larger than one holder can also be handled. In FIG. 4A the holders 6′ each carry one article, a box P1, in FIG. 4B four holders 6′ together carry two crates P2, in FIG. 4C the four holders 6′ together carry one larger crate P3. In the cases of FIGS. 4B and 4C the platforms will be adapted thereto as regards length.

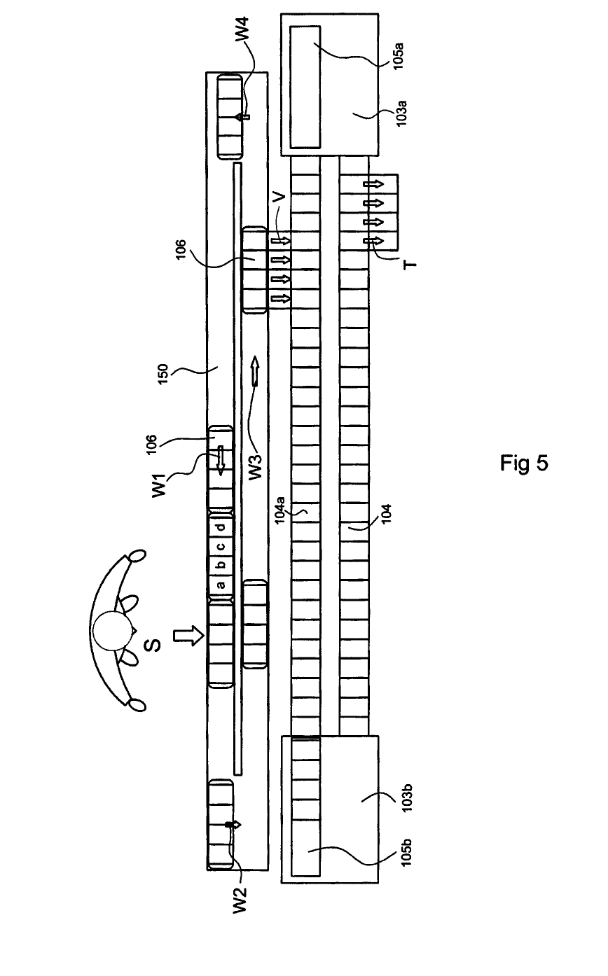

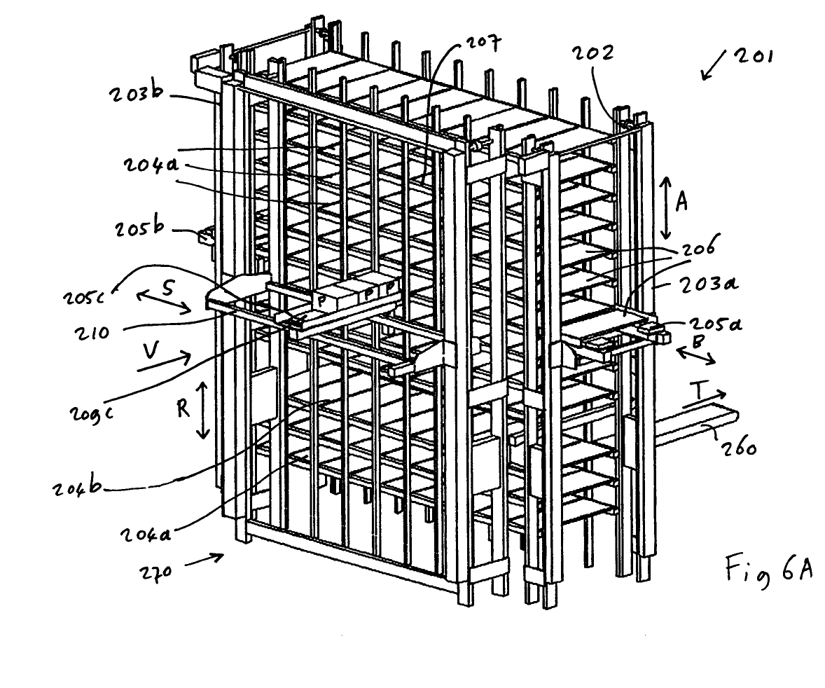

To illustrate the supply, in FIG. 5 in front of the device 101, which in principle corresponds with device 1, a supply conveyor 150 is positioned, on which multiple holders 106 with four compartments a-d. The filler places the articles (direction S) in an empty holder 106 that arrives in direction W1. The loaded holder 106 runs, directions W2, W3, to the location of entry, where an ejector that is not shown delivers the articles in the direction V to a holder 106 on the entry level 104a. In the manner described above, said holder 106 later ends up on platform 105a, which in this example by way of example is adapted for supporting one holder 106.

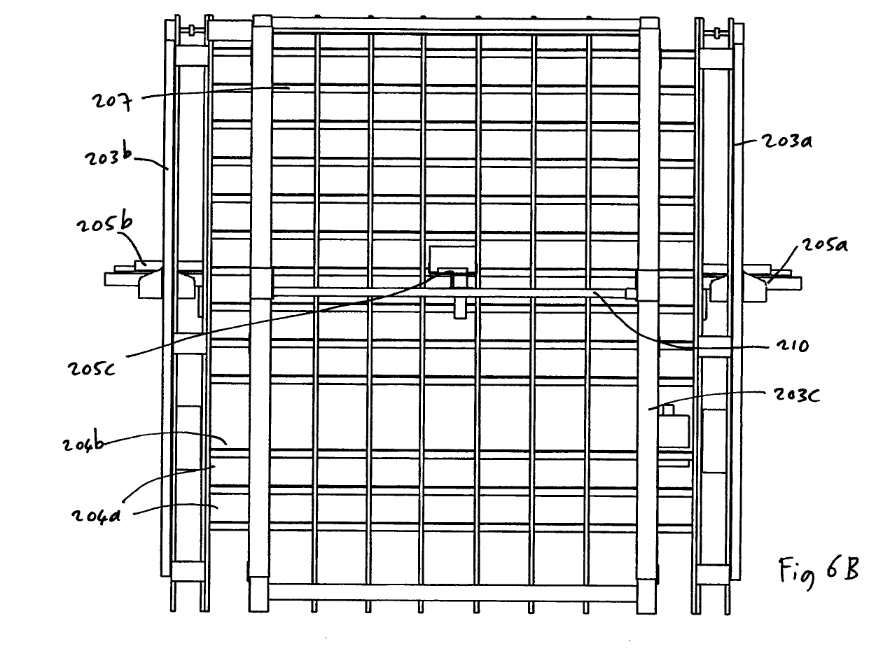

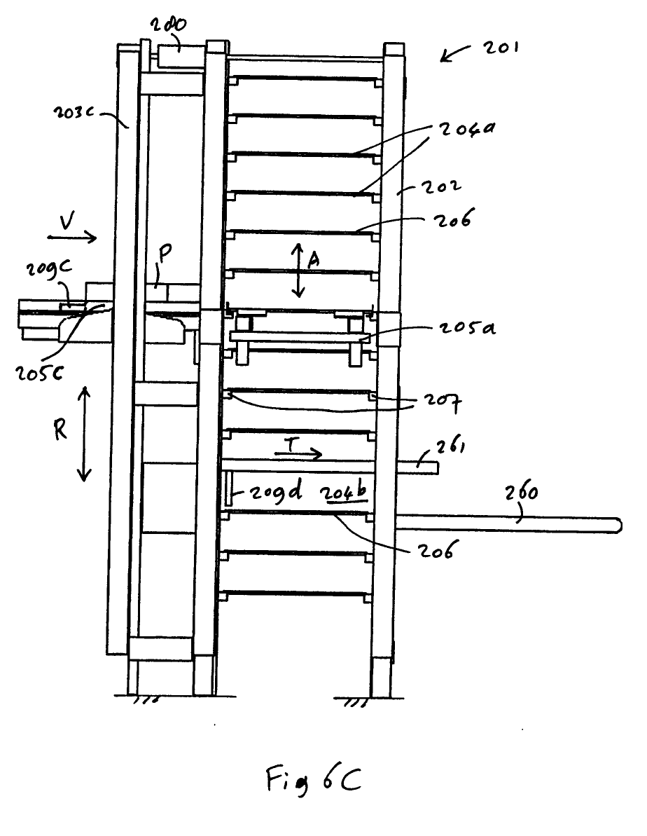

The exemplary embodiment 201 of a device according to the invention shown in FIGS. 6A-C, comprises a frame 202 in which in a column set-up a number of sections 204 are housed. The majority of the sections 204 is storage section 204a, which in principle correspond with the storage sections discussed above and comprise support profiles 207 extending in longitudinal direction on which a series of holders 206 is supported, in an easy slidable manner.

Elevator shafts 203a,b have been arranged at both longitudinal sides, in which shafts, in the manner discussed above, platforms 205a,b can be moved up and down (direction A) by first movement means. The platforms 205a,b correspond with the platforms discussed above including drive.

At one longitudinal side, the front side, an entry device 270 is provided, comprising an elevator shaft 203c, in which a feeder device 205c is movable by fourth movement means, and namely movable up and down (direction R), by motor 280. The feeder device 205c can also be moved in longitudinal direction (direction S) on rails 210 by the fourth movement means, by means of a motor that is not shown.

The feeder device 205c is provided with a pusher 209c (third movement means) with which articles P supported by the feeder device 205c can be moved in the (entry) direction V.

One of the sections 204 is adapted as discharge or exit section 204b. Another option is designing several of the sections 204 like that. In the frame 202, at the location of the discharge section 204b a pusher or ejector 209d (fifth movement means) is provided, which is guided by guides 261 and is able to move articles P supported on a holder 206 situated there in said section in the direction T, in order to transfer them to output device 260, which is situated at the rear of the frame 202. Alternatively it is also possible to unload several holders 206 simultaneously, in which case several ejectors or pushers 209d are present and the output belt will be broader or an output belt that extends along the discharge section 204b.

All drives are controlled by a control unit, which is not shown, with programmable computer.

In use supplied articles P that have to be stored are placed on the feeder device the platform 205c of the entry device 270, and by movement in the directions R and S are brought in front of the correct storage section 204a at the location of the correct holder 206. Subsequently the ejector 209c is operated and the article P or the articles P are shifted onto the selected holder 206. Depending on the relative dimensions of article P with respect to the length and width of the holder, several articles can be placed adjacent to each other (in latitudinal direction or in longitudinal direction) on a holder. In the example three articles P are shifted onto the holder 206.

When certain articles need to be delivered, platforms 205a,b are deployed. In a manner as discussed above the platforms 205a,b are brought in line with the storage section 204a in question, and one or more of its holders 206, loaded with the articles in question, are shifted onto (first) platform 205a in the manner discussed above. From the platform 205b the holders in said section are replenished. The platforms 205a,b are subsequently brought into line with discharge section 204b, and in the manner discussed above the loaded holders 206 are transferred to said section, wherein the empty holders are received by the second platform.

These actions are repeated/continued until the discharge section 204b is filled as desired. An assortment of articles can also be made, originating from different storage sections.

Then the ejectors or slides 209d are operated, which move along guides 261 and shift the articles P onto the output device 260, direction T.

In this case the holders 206 are substantially free from (without) threshold or something similar at the longitudinal side of the frame, in order to be able to be freely accessible to an article moving in transverse direction V or T.

It is noted that the device 201 and comparable devices according to the invention can also be designed the other way round, in which case one or more sections (such as 204b) are designed as entry section and the platforms at the longitudinal ends are used for distribution over the storage sections. The ejectors, such as ejectors 209d, may in that case have been replaced by for instance pulls or hooks, in order to pull in the articles. The discharge can then take place by means of an output device that is similar to the feeder device but works the other way round. Instead of the ejector provided thereon, for instance a pull or hook may be present, which pulls the articles from a holder onto the platform. Other displacers are possible to effect the desired movements.

The above description is included to illustrate the operation of preferred embodiments of the invention and not to limit the scope of the invention. Starting from the above explanation many variations that fall within the spirit and scope of the present invention will be evident to an expert.

1-37. (canceled)

38. Device for the storage of articles and the formation of groups of articles therefrom, comprising a frame having a first series of mutually parallel elongated storage sections, preferably positioned in a column set-up, that extend between a first end and a second end of the frame, furthermore comprising a number of holders, such as carriers, for the articles, wherein the storage sections are provided with holder supports on which a number of the holders can be supported for storage of the articles, wherein at the first end and the second end of the frame first and second platforms, respectively, have been arranged which each are adapted for accommodating at least one holder, and first movement means for moving said platforms, preferably simultaneously, from the one storage section to another storage section, wherein the device is provided with second movement means for horizontally moving at least one holder from the platform at the first end of the frame to the holder supports of a selected storage section while moving one or more holders, preferably representing a same holder length, from the selected storage section to the platform at the second end of the frame, wherein the device has main or longitudinal sides extending between the frame ends and at least at one longitudinal side is provided with one or more feeder devices and with third movement means for discharging an article from the feeder device to a selected storage section, wherein the device is provided with fourth movement means for moving the feeder device to the selected storage section.

39. Device according to claim 38, wherein the third movement means are provided on the feeder device, preferably as a displacer, such as an ejector, provided on the feeder device for discharging and/or receiving the article to and from, respectively, (a holder in) the selected storage section, which displacer preferably is active in a horizontal direction transverse to the longitudinal direction of the storage section.

40. Device according to claim 39, wherein the displacer engages onto the article.

41. Device according to claim 38, wherein the fourth movement means are able to move the feeder device up and down and/or reciprocally along the longitudinal side to a selected holder in a selected storage section.

42. Device according to claim 38, wherein the device is provided with several feeder devices at a same longitudinal side, wherein the (third and fourth) movement means of said feeder devices preferably can be operated independent from each other.

43. Device according to claim 38, wherein the holders on at least one of the longitudinal sides of the frame are freely accessible to an article.

44. Device according to claim 43, wherein the holders on both longitudinal sides of the frame are freely accessible to an article.

45. Device according to claim 38, wherein the one longitudinal side of the frame forms the entry side and the opposing longitudinal side the exit side.

46. Device according to claim 38, at one or more storage section (exit or discharge sections) provided with fifth movement means for removing an article from the storage section in question, preferably in the form of one or more displacers, such as ejectors, that preferably engage onto the article.

47. Device according to claim 38, wherein the second movement means are also provided for horizontally moving at least one holder from the platform at the second end of the frame to the holder supports of a selected storage section while moving one or more holders representing a same holder length from the storage section to the platform at the first end of the frame.

48. Device according to claim 38, wherein both platforms are adapted for supporting more than one holder.

49. Device according to claim 38, wherein the device is provided with means for horizontally moving a holder from a platform to the holder supports of a selected storage section while the other platform receives a holder from said storage section.

50. Device according to claim 38, wherein the holders can be removed in a direction transverse to the storage section in question.

51. Device according to claim 38, provided with a programmable control system for controlling the first, second, third and fourth, and if present fifth, movement means, wherein, preferably, the control system is programmed for having the articles moved exclusively by the first platform past the ends of the storage sections, and/or the control system is programmed for having the second platform exclusively move empty holders.

52. Device according to claim 38, wherein the second movement means are provided on the first and/or the second platform.

53. Device according to claim 38, wherein the second movement means directly engage onto a holder at the end of the row of holders that is situated on the storage section with both platforms, wherein, preferably, the second movement means engage onto a holder that is situated on a platform, particularly are designed as pusher.

54. Device according to claim 38, wherein the holders have a horizontal dimension in the direction of the storage section that is a singular or multiple of a module size.

55. Device according to claim 54, wherein the holders have a horizontal dimension in the direction of the storage section that is a singular of a module size and wherein each storage section supports a number of N1 holders and the number of storage sections is N2, wherein
the number of holders in the device is at least N1×N2+1, preferably at least N1×N2+2 and/or
the maximum number of holders to be contained by a platform is N3, wherein the number of holders in the device is at least N1×N2+N3.

56. Device according to claim 54, wherein one or several holders have a length of a multiple of a module size, wherein in case of a given number of storage sections of N2 and a number of module sizes of N4 per storage section, the overall length occupied by holders is at least N2×N4+1, preferably N2×N4 +2, wherein, preferably, the maximum number of module sizes that a platform may contain is N5 and the overall length occupied by the holders is N2×N4+N5.

57. Device according to claim 38, wherein the third movement means and, if present fifth movement means, the feeder device and the output device are designed to be active the other way round so that the feeder device forms an output device and the discharge section forms an entry section.

58. Method for keeping articles in store, wherein the articles are stored in a device, which device comprises a frame having a first series of elongated storage sections placed parallel to each other, preferably in a column set-up, and extending between a first end and a second end of the frame, furthermore comprising a number of holders for the articles, wherein the storage sections are provided with holder supports on which a number of the holders can be supported for storage of the articles, wherein at a longitudinal side of the frame articles are taken to a selected storage section and are supplied thereto, in a direction transverse to the longitudinal direction of the storage section, wherein for discharging selected stored articles from the device, the holders holding those articles are moved to a longitudinal end of the frame and at that location are taken by a platform to a storage section intended for discharge (discharge or exit section) and are transferred thereto, wherein the articles are transferred from the discharge section to an output device.

59. Method according to claim 58, wherein at the first end and the second longitudinal end of the frame a first and a second movable platform, respectively, has been arranged wherein for retrieving the articles from store, the first platform and the second platform are taken to a selected storage section and an empty holder is received from the second platform on the holder supports of said storage section while discharging a holder with article from said storage section to the first platform, after which the holder with article is taken by the first platform to the discharge section, where the holder in question is received from the first platform onto the holder supports of the discharge section while transferring an empty holder from said same section to the second platform.

60. Method according to claim 59, wherein the first platform is used exclusively for moving the loaded holders and the second platform is used exclusively for moving empty holders.

61. Method according to claim 58, wherein the articles are supplied to a selected storage section by placing the articles on holders that are already present in there.

62. Method according to claim 58, wherein in transverse direction several, preferably identical articles, are placed adjacent to each other on a holder in the selected storage section.

63. Method according to claim 58, wherein the articles are taken to the selected storage section by a vertically movable feeder device.

64. Method according to claim 58, wherein the articles are taken to the selected holder in the selected storage section by a horizontally and/or vertically movable feeder device.

65. Method according to claim 58, wherein the articles are discharged from the discharge section, preferably in a direction transverse to the longitudinal direction of the discharge section, by means of dischargers, such as ejectors, arranged in the frame active at the location of the holder in question.

66. Method according to claim 58, wherein articles from different storage sections are brought together in the discharge section.

67. Method according to claim 58, wherein the longitudinal side of entry is opposed to the longitudinal side of the discharge/exit.

68. Method according to claim 58, wherein for each holder from the first platform, received by a section and provided with an article, one empty holder of the same section is discharged to the second platform.

69. Method according to claim 31, wherein for each empty holder from the second platform and received by a storage section, one holder provided with an article is discharged from the same storage section to the first platform.

70. Method according to claim 58, wherein the supplied articles are placed in different storage sections, particularly in accordance with the type or the intended use of the articles.

71. Method for keeping articles in store, wherein the articles are stored in a device, which device comprises a frame having a first series of elongated storage sections placed parallel to each other, preferably in a column set-up, and extending between a first end and a second end of the frame, furthermore comprising a number of holders for the articles, wherein the storage sections are provided with holder supports on which a number of the holders can be supported for storage of the articles, wherein at a longitudinal side of the frame the articles are taken to a storage section designed as entry section and are supplied thereto, in a direction transverse to the longitudinal direction of the entry section, wherein for storing entered articles in a selected storage section of the device, the holders holding those articles are moved to a longitudinal end of the frame and at that location are taken by a platform to the selected storage section and transferred thereto, wherein the articles are transferred from the storage section to an output device preferably in a direction transverse to the longitudinal direction of the storage section.

72. Method according to claim 71, wherein the articles from the storage section are received by an output device that is vertically and/or horizontally moved along the storage sections, between a selected position for reception of an article and a location of output.

73. Device for storing articles and the formation of groups of articles therefrom, comprising a frame having a series of mutually parallel elongated storage sections, positioned in a column set-up, that extend between a first end and a second end of the frame, further comprising a number of holders, such as carriers, for the articles, wherein the storage sections are provided with holder supports on which a number of the holders can be supported for storage of the articles, wherein the frame has longitudinal ends and longitudinal sides extending in between them, wherein the device at a longitudinal side is provided with a feeder device that is movable to a selected storage section and to a selected position, particularly holder, along it for transferring one or more of the articles placed on the feeder device to said selected position/holder and transferring it thereto, wherein at the longitudinal ends the device is furthermore provided with, one set of movable elevators, preferably situated in line, for moving the holders and/or articles from the one storage section to another storage section, including an exit/discharge section intended for exit/discharge of articles, wherein at a longitudinal side, preferably the longitudinal side opposing the feeder device longitudinal side, the device is provided discharge means for from the exit/discharge section discharging articles to an output device.
